(19) United States
(12) Patent Application Publication
(10) Pub. No.: US 2019/0069513 A1
(43) Pub. Date: Mar. 7, 2019

(54) Animal Temperature Regulation Garment

(71) Applicant: Michael Bevis, Denver, CO (US)

(72) Inventor: Michael Bevis, Denver, CO (US)

(21) Appl. No.: 15/986,669

(22) Filed: May 22, 2018

Related U.S. Application Data
(63) Continuation-in-part of application No. 62/509,661, filed on May 22, 2017.

(51) Int. Cl. A01K 13/00

(52) U.S. Cl. CPC A01K 13/006

(57) ABSTRACT

An animal temperature regulation garment includes multiple pouches with temperature control packets which allow an animal, such as a pet dog, to play or exercise comfortably in hot or cold climates. When it would otherwise be too hot for outdoor activity, the animal temperature regulation garment may be worn with cooling packs in the pouches, allowing the animal to engage in outdoor activity while reducing the likelihood of heat stroke or other heat-related illness. In the cold, the cooling packs in the temperature regulation garment may be replaced with heating packs.

### RELATED APPLICATIONS

This Utility Patent Application claims the benefit of priority to U.S. Provisional Patent Application Ser. No. 62/509,661 filed on May 22, 2017.

### FIELD OF THE INVENTION

The present invention pertains generally to an article of clothing for an animal. More specifically, the present invention pertains to a temperature regulation garment for an animal, such as a pet dog, which provides temperature control in order to enable the animal to exercise or play outside in harsh environments.

### BACKGROUND

Many animals require regular physical activity in order to maintain good physical and mental health. The need for exercise is well-known among experts. Zookeepers, for example, often ensure that certain animals receive sufficient exercise. Some efforts have been undertaken to make pet owners aware of their pet's exercise needs also. The Humane Society provides suggestions for exercising pets, particularly cats and dogs, on their website. Even WebMD has an article on the exercise of dogs and behavioral problems that arise with insufficient physical activity.

Despite the need to exercise animals which are in the care of humans, some precautions must be taken. Animals can be particularly sensitive to extreme climates and sudden changes of temperature. In the summer months, especially in hot areas such as deserts, heat stroke and other heat related illnesses can threaten the health—and even the life—of active animals. Organizations such as the Humane Society have suggested limiting the amount of pet exercise during warmer periods of the year, and limiting exercise to early morning or late evening hours during those warm seasons. Pet owners and other animal caretakers thus find themselves in a predicament: If they exercise their animals, they face heat-related problems, but if they don't exercise their animals, they face inactivity-related problems.

The cold also poses problems for animals. Hypothermia and other cold related illnesses can threaten animals, posing many of the same risks as excessive heat. In areas with harsh winters, pet owners are generally recommended to keep their pets indoors during the winter. In this way they lose the benefits of physical activity in order to avoid the risks of the cold. There is thus a long-felt, unsolved need for an invention that allows animals to safely exercise in the heat or cold.

In light of the above, it would be advantageous to provide a temperature regulation garment for an animal to protect the animal from hot or cold weather during periods of activity. It would be further advantageous to provide a temperature regulation garment for an animal that allows for the insertion of heating or cooling pouches in order to maintain a comfortable temperature for the animal during the period of activity. Finally, it would be advantageous to provide a temperature regulation garment that minimizes the risk of temperature-related health problems and allows an animal to engage in outdoor physical activity during the summer or winter, especially in harsh climates.

### SUMMARY OF THE INVENTION

The present invention provides a temperature regulation garment for an animal under the care of humans. The temperature regulation garment includes a garment with pouches, temperature control packets sized to fit in the pouches, and fasteners designed to secure the temperature regulation garment to an animal. The specific size and dimensions of the temperature regulation garment necessarily vary among embodiments in order to fit the particular breed and size of the animal that will wear the garment.

A preferred embodiment uses an elastic waistband with a fastener to fasten the waistband around the animal's waist. A neck opening allows the garment to be placed around the animal's neck. An additional fastener is located on each side of the garment. Each side fastener has a first end on a side of the garment, and an opposing end proximate the neck opening, which allows for the garment to be secured around the animal's front legs or arms. The garment contains left and right side pouches with fasteners to close the pouches, and a chest pouch with a corresponding fastener to close it. The pouches allow for the insertion of temperature control packets that maintain either a warm or a cool temperature for the animal. This embodiment is particularly useful with dogs, and may be manufactured in various sizes to fit various breeds of dog.

When used with an animal, such as a dog, the temperature control packets are first selected and inserted. Cold packets are inserted if the animal will exercise in a warm area, but hot packets are inserted if the animal will exercise in a cold area. Once the packets are inserted, the pouches are closed by sealing or connecting their fasteners. Then the animal's head is placed through the neck opening, and the left and right side fasteners are secured or fastened on the animal's upper back, bringing the garment around the animal's left and right front legs (or arms). Finally, the waistband is fastened around the animal's waist, and the animal is ready to engage in outdoor physical activity.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a top, or outside view of a preferred embodiment of an animal temperature regulation garment with its fasteners in an unfastened configuration, showing the general shape and layout of the garment and the location of its fasteners;

FIG. 2 is a bottom, or inside view of the animal temperature regulation garment of FIG. 1, showing the location of the pouches for insertion of temperature control packets;

FIG. 3 is a bottom view of the animal temperature regulation garment of FIG. 1, with the fasteners in a fastened configuration, as used when the temperature regulation garment is being worn by an animal;

FIG. 4 is a top view of the animal temperature regulation garment of FIG. 1, with the fasteners in a fastened configuration, as used when the temperature regulation garment is being worn by an animal;

FIG. 5 is a left side view of the animal temperature regulation garment of FIG. 1, with the fasteners in a fastened configuration, as used when the temperature regulation garment is being worn by an animal;

FIG. 6 is an inside view of the animal temperature regulation garment of FIG. 1, with the fasteners in an unfastened configuration, and showing the insertion of temperature control packets into the pouches; and

FIG. 7 is a left side view of an animal temperature regulation garment as worn by a dog.

### DETAILED DESCRIPTION

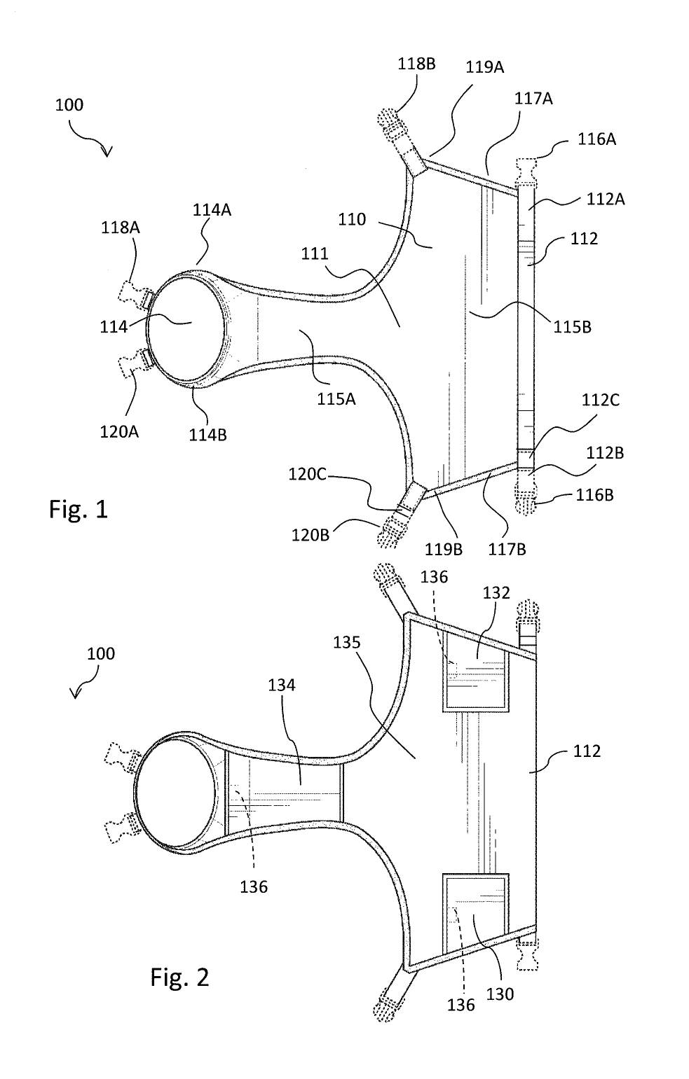

Referring initially to FIG. 1, a top view showing the outside of an animal temperature regulation garment is shown and generally labeled 100. The animal temperature regulation garment 100 includes a garment made of a body 110, a waistband 112, and a neck opening 114.

The body 100 includes an exterior side 111, an interior side 135 (shown in FIG. 2), a front portion 115A, and a rear portion 115B. The rear portion 115B has a left side 117A, a right side 117B, a left edge 119A, and a right edge 119B.

The waistband 112 has a first end 112A and a second end 112B. The neck opening 114 has an exterior left side 114A and an exterior right side 114B.

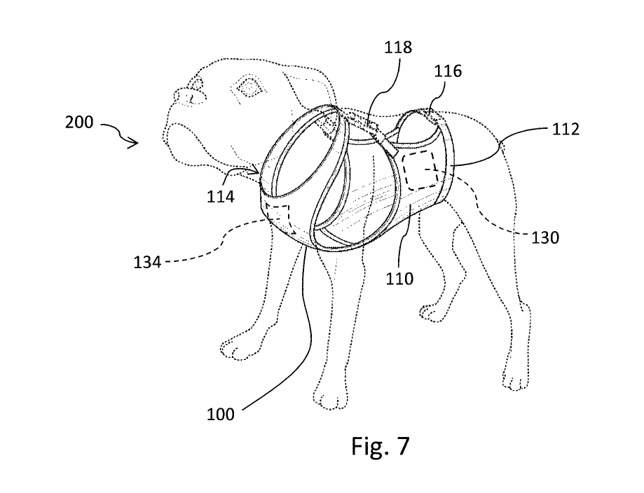

In a preferred embodiment, the body 110 is an 11 oz. weight 92/8 polyester spandex material. The waistband 112 has a waistband fastener 116 (shown in FIG. 4) which allows the waistband 112 to be fastened around the waist of an animal 200 (shown in FIG. 7). In FIG. 1, the waistband fastener 116 is shown in its component parts: a left waistband fastener 116A is attached to a first end 112A of the waistband 112, and a right waistband fastener 116B is attached to a second end 112B of the waistband 112. In the preferred embodiment shown in FIG. 1, the waistband fastener 116 is a plastic side-release buckle, with the left waistband fastener 116A being the female end of the buckle, and the right waistband fastener 116B being the male end of the buckle.

A plastic side-release buckle is particularly apt for use with the waistband 112 due to its low cost and its strength in fastening one end of the waistband 112 to the other end. Nonetheless, other fastener types and materials are contemplated for use with the present invention, as appropriate to any particular circumstances in which an embodiment of the invention may be used. For example, some embodiments use plastic buckle, D-ring, or tri-glide style fasteners for the waistband fastener 116. Various embodiments also use snaps, hook and loop fasteners (such as those sold under the brand name Velcro®), or other fasteners in order to secure the waistband 112.

The waistband 112 is adjustable to enable the animal temperature regulation garment 100 to fit well on multiple breeds of the animal 200 with which it is being used. The waistband has an extension portion 112C that allows the waistband 112 to stretch around the animal 200. Extension strap 112C is, in a preferred embodiment, elastic and longitudinally stretchable to ensure a close fit of the garment on an animal. Alternatively, portion 112C may be an extendable strap that can be adjusted in its length to accommodate animals having different sizes. In use, the portion 112C may be extended for larger animals, or shortened for smaller animals. Both the waistband 112 and the body 110 have an elasticity allowing the animal temperature regulation garment 100 to fit tightly but comfortably around the animal.

A left body fastener 118 (shown in FIG. 4), including a left neck fastener 118A attached at the exterior left side 114A of the neck opening 114, and a left edge fastener 118B attached at the left edge 119A of the rear portion 115B of the body 110, allow for the garment 100 to be secured around the animal's 200 left front leg or left arm. Likewise, a right body fastener 120, including a right neck fastener 120A attached at the exterior right side 114B of the neck opening 114, and a right edge fastener 120B attached at the right edge 119B of the rear portion 115B of the body 110, allow for the garment 100 to also be secured around the animal's 200 right front leg or right arm. As with the waistband fastener 116, the left body fastener 118 and right body fastener 120 are shown as plastic side-release buckles, which are used in a preferred embodiment. The right edge fastener 120B also has an extension strap 120C to allow the animal temperature regulation garment 100 to fit around different size animals 200. Extension strap 120C is, in a preferred embodiment, elastic and longitudinally stretchable to ensure a close fit of the garment on an animal. Alternatively, portion 120C may be an extendable strap that can be adjusted in its length to accommodate animals having different sizes. In use, the portion 120C may be extended for larger animals, or shortened for smaller animals. The left neck fastener and right neck fastener 118A and 120A are female ends of the buckles, and the left edge and right edge fasteners 118B and 120B are male ends of the buckles. Snaps, hook and loop fasteners, or other fasteners, including those described above for use with the waistband 112, may also be used in place of, or in addition to, the side-release buckles.

Referring now to FIG. 2, a bottom view showing the inside, or skin-side, of the animal temperature regulation garment 100 is shown. The bottom, or interior side 135 of the body 110 of the animal temperature regulation garment 100 contains embedded pouches for the insertion of temperature control packets. In particular, a left pouch 130 adjacent to the left side 117A of the rear portion 115B of the body 110 allows for a side temperature control packet 150 (shown in FIG. 6) to provide a comfortable temperature to the animal's 200 left side; a right pouch 132 adjacent to the right side 117B of the rear portion 115B of the body 110 allows for the side temperature control packet 150 to provide a comfortable temperature to the animal's 200 right side; and a chest pouch 134 adjacent to the front portion 115A of the body 110 allows for a chest temperature control packet 152 (shown in FIG. 6) to provide a comfortable temperature to the animal's 200 chest area.

Each pouch has a pouch fastener 136 attached to the interior side 113 of the body 110 to secure a temperature control packet into the pouch. More specifically, the left pouch 130 has a left pouch fastener 136 on the interior side of the left pouch 130; the right pouch 132 has a right pouch fastener 136 on the interior side of the right pouch 132; and the chest pouch 134 has a chest pouch fastener 136 on the interior side of the chest pouch. In a preferred embodiment, the fasteners 136 are made of hook and loop fasteners, but snaps or other fasteners may also be used. Also as shown in FIG. 2, the waistband 112 is integral to the garment 100, the waistband 112 having been sewn across the rear portion 115B of the body 110.

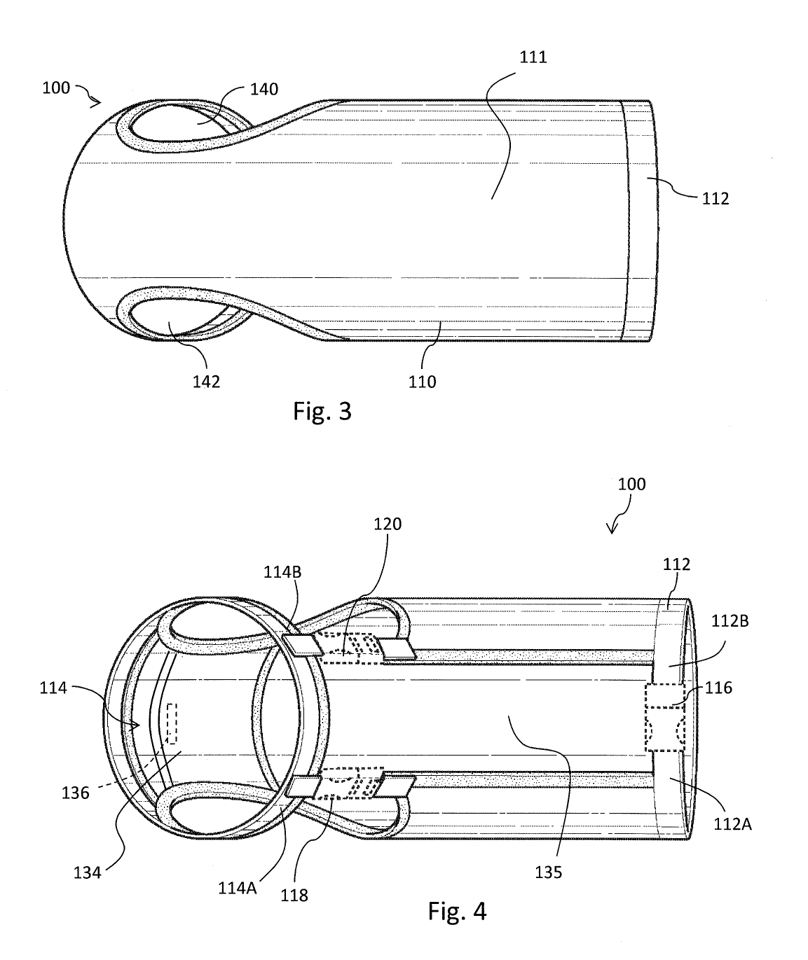

Referring now to FIG. 3, it can be appreciated that when the left body fastener 118 (shown in FIG. 4) is secured, a left leg opening 140 is formed. In use, the left body fastener 118 will be secured around the animal's 200 left front leg or left arm, thus forming the left leg opening 140 around the left front leg or left arm. Likewise, when the right body fastener 120 (shown in FIG. 4) is secured around the animal's 200 right front leg or right arm, a right leg opening 142 will be formed around the animal's 200 right front leg or right arm.

Referring now to FIG. 4, the right body fastener 120 and left body fastener 118 are shown in their fastened configuration, as they would be when the animal temperature regulation garment 100 is worn by the animal 200. The left body fastener 118 is placed in a fastened configuration when the left edge fastener 118B is securely attached to the left neck fastener 118A. When in this configuration, the left leg opening 140 is formed and present in the animal temperature regulation garment 100. Likewise, the right body fastener 120 is placed in a fastened configuration when the right edge fastener 120B is securely attached to the right neck fastener 120A. When in this configuration, the right leg opening 142 is formed and present in the animal temperature regulation garment 100. Finally, the waistband fastener 116 is placed in a fastened configuration when the right waistband fastener 116B is securely attached to the left waistband fastener 116A. When in this configuration while the animal 200 is wearing the animal temperature regulation garment 100, the waistband 112 is wrapped and secured around the animal's 200 waist, leaving the majority of the garment 100 covering the animal's 200 chest and extending to its left and right sides, with its head passed through the neck opening 114.

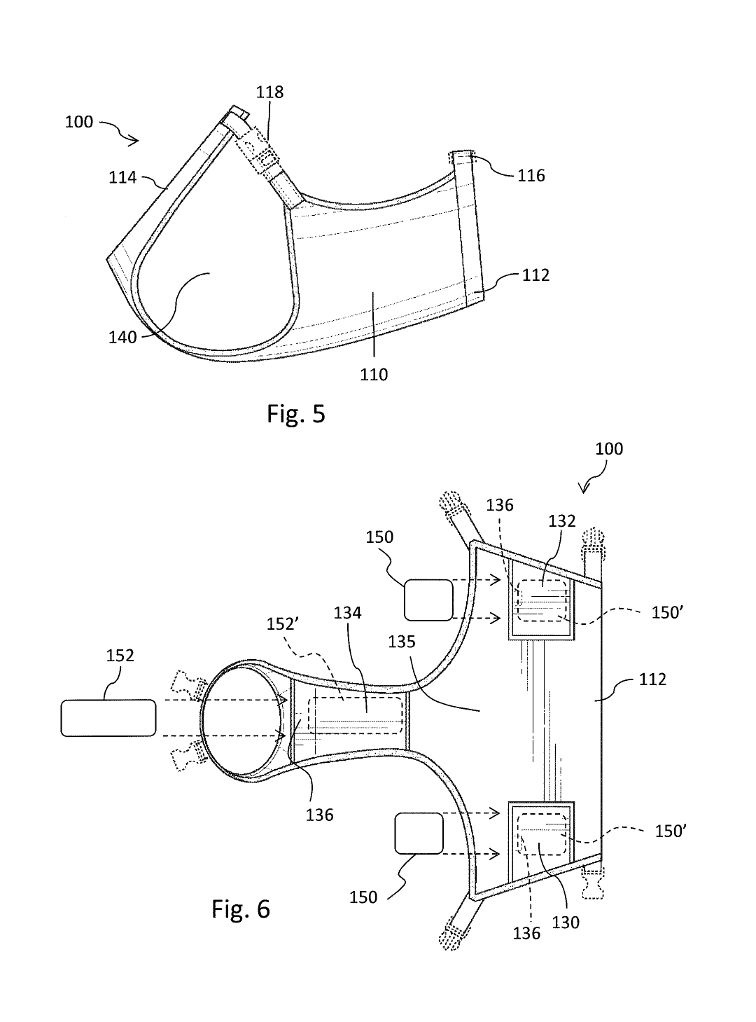

Referring now to FIG. 5, a left side view of the animal temperature regulation garment 100 is shown, with the waistband fastener 116, left body fastener 118, and right body fastener 120 (not visible in FIG. 5) in their fastened configuration and the left leg opening 140 visible.

Referring now to FIG. 6, the insertion of the side temperature control packets 150 and the chest temperature control packet 152 into the right pouch 132, the left pouch 130, and the chest pouch 134 is depicted. The side temperature control packets 150 and chest temperature control packets 152 are filled with a substance designed to maintain either an elevated or a reduced temperature over extended periods of time, usually at least an hour, in order to provide temperature control to the animal during the exercise period. The side and chest temperature control packets 150 and 152 may be heated or cooled depending on the environmental conditions. One embodiment of the side and chest temperature control packets 150 and 152 can be used as both heating and cooling packets, and would be either heated or cooled by the animal's owner or keeper before use.

The right pouch 132, left pouch 130, and chest pouch 134 may not be the same size, and thus the side and chest temperature control packets 150 and 152 may also differ in size in order to correspond to the size of each pouch of the garment 100. As depicted in FIG. 6, side temperature control packets 150 of a substantially square shape are used in the left pouch 130 and the right pouch 132 in a preferred embodiment. In the preferred embodiment depicted, the chest pouch 134, which extends from the bottom of the neck along the chest of the animal 200, is longer and narrower than the left pouch 130 and the right pouch 132, and so the corresponding chest temperature control packet 152 is longer and narrower than the side temperature control packets 150. The chest temperature control packet 152 thus has a substantially rectangular shape. As the number, locations, sizes, and shapes of the left, right, and chest pouches 130, 132, and 134 may vary in other embodiments, the side and chest temperature control packets 150 and 152 may also vary in number, sizes, and shapes. Once inserted into the pouches 130, 132 and 134, the temperature control packs 150 and 152 are retained in place with fasteners 136 to prevent the pouches from falling from the garment 100 during physical activity of the pet.

Referring now to FIG. 7, the animal temperature regulation garment 100 is depicted as worn by an animal 200, more specifically a dog in this illustration. In use, the elastic waistband 112 is fastened around the animal's waist with the waistband fastener 116; the waistband fastener 116 being fastened on the lower back of the animal 200. The left body fastener 118 fastens on the left side of the animal's 200 upper back and brings the garment 100 around the animal's 200 left leg, while the right body fastener 120 (not shown in FIG. 7) fastens on the right side of the animal's 200 upper back and brings the garment 100 around the animal's right leg. The animal's head protrudes from the neck opening 114. The left pouch 130 and right pouch 132 contain side temperature control packets 150 (shown in FIG. 6), and the chest pouch 134 contains a chest temperature control packet 152 (shown in FIG. 6), allowing the animal 200 to maintain a comfortable temperature during outdoor activity. For example, on a hot day in a warm climate, the temperature control packets are cooled and maintain a low temperature to keep the animal 200 cool during the exercise period. Alternatively, the temperature control packets are warmed and allow the animal 200 to safely engage in physical activity in colder climates, for example, while playing in the snow. The elasticity of the garment 100 allows it to fit tightly around the animal 200, thus holding the side and chest temperature control packets 150 and 152 closely against the skin of the animal 200 and increasing the effectiveness of regulating the animal's 200 temperature. Also, due to the tight fit of the garment 100 and the elasticity of body 110, there may be some bulging of the garment in the area of the left, right, and chest pouches 130, 132, and 134 while the garment 100 is being worn with temperature control packets 150 and 152 inserted maintaining contact between the temperature control packet and the animals 200 body.

While there have been shown what are presently considered to be preferred embodiments of the present invention, it will be apparent to those skilled in the art that various changes and modifications can be made herein without departing from the scope and spirit of the invention.

I claim:

1. An animal temperature regulation garment, comprising:
a body having an exterior side and an interior side, said body having a front portion formed with a neck opening, and a rear portion having a waistband;
said neck opening having an exterior right side and an exterior left side;
said rear portion of the body having a right side with a right edge and a left side with a left edge
said waistband having a first end and a second end and having a waistband fastener comprising a left waistband fastener attached to said first end of the waistband engageable to a right waistband fastener attached to said second end of said waistband;
a left edge fastener attached to said left edge of the rear portion of the body and attachable to a left neck fastener on said left side of the neck opening to form a left leg opening for an animal; and
a right edge fastener attached to said right edge of the rear portion of the body and attachable to a right neck fastener on said right side of the neck opening to form a right leg opening for an animal; and
said body formed with one or more pouches on the interior side to receive a temperature control pack.

2. The invention of claim 1, further comprising: a left pouch attached to the left side of the rear portion of the interior side of the body; and a right pouch attached to the right side of the rear portion of the interior side of the body.

3. The invention of claim 2, further comprising: a chest pouch; said chest pouch attached to the front portion of the interior side of the body.

4. The invention of claim 3, further comprising a pouch fastener to attach the left pouch to the rear portion of the interior side of the body to secure a side temperature control packet.

5. The invention of claim 4, further comprising said pouch fastener to attach the right pouch to the right side of the rear portion of the interior side of the body to secure the side temperature control packet.

6. The invention of claim 5, further comprising said pouch fastener to attach the chest pouch to the front portion of the interior side of the body to secure a chest temperature control packet.

7. The invention of claim 6, wherein the side temperature control packets and the chest temperature control packet are filled with a substance designed to maintain either an elevated or a reduced temperature over extended periods of time, preferably an hour.

8. The invention of claim 7, wherein the body is made of an elastic, washable material.

9. The invention of claim 8, further comprising an elastic portion attached to said second end of said waistband.

10. The invention of claim 9, wherein the waistband is elastic.

11. The invention of claim 9, wherein the waistband is adjustable.

12. The invention of claim 1 further comprising a first strap extension extending between said left edge fastener and said rear portion, and a second strap extension extending between said right edge fastener and said rear portion.
